(19) United States
(12) Patent Application Publication
(10) Pub. No.: US 2004/0214571 A1
(43) Pub. Date: Oct. 28, 2004

(54) System and method for managing the association of device with a piconet

(75) Inventor: Seong-Seol Hong, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/831,310

(22) Filed: Apr. 26, 2004

(30) Foreign Application Priority Data
Apr. 25, 2003 (KR) 2003-26425

(51) Int. Cl. H04Q 7/20

(52) U.S. Cl. 455/435.1

(57) ABSTRACT

A system that manages associations of devices with a piconet is provided. The system includes a piconet-device association coordinator, which receives, from a first device, a second association request command that indicates a proper allocation of a device ID to the first device, sets an association elapsed period of the first device to an initial value, and registers the first device and records the association elapsed period to an association device list so that the first device corresponds to the association elapsed period; and a piconet-device associator, which updates an association device list of the first device by referring to the association device list, extracts an association elapsed period of a second device registered on the updated association device list from the updated association device list when the first device requests communication with the second device, and performs the communication between the first and second devices if the extracted association elapsed period is shorter than an association timeout period.

### BACKGROUND OF THE INVENTION

This application claims priority from Korean Patent Application No. 2003-26425, filed on Apr. 25, 2003, in the Korean Intellectual Property Office, the disclosure of which is incorporated herein in its entirety by reference.

1. Field of the Invention

The present invention relates to a system and method for managing the association of a device with a piconet.

2. Description of the Related Art

FIG. 1 is a block diagram of a piconet according to the IEEE 802.12.3 standards.

According to the IEEE 802.12.3 standards, a piconet is a wireless ad-hoc data communication system in which individual data devices can communicate with one another. The piconet is distinguished from other types of data networks due to its communication availability within a range of 10 m. In other words, the piconet is discerned from conventional Local Area Networks (LANs), Metropolitan Area Networks (MANs), and Wireless Area Networks (WANs).

Referring to FIG. 1, a piconet includes a plurality of devices, one of which is a piconet coordinator. The piconet coordinator provides timing of the piconet via a beacon. The piconet coordinator also manages requests for Quality of Service (QOS), manages a power save mode, and controls access to the piconet. The IEEE 802.12.3 standards prescribe that a device can constitute a subsidiary piconet. An IEEE 802.15.3 Media Access Control (MAC) provides for a fast connection, an ad-hoc network, data transmission to support QOS, security, dynamic membership, and efficient data transmission.

Devices that request to be involved in the piconet must undergo an association process. The association of the devices with the piconet requires device identifications (IDs), i.e., unique piconet identifiers, to be allocated to the devices. In order to reduce overhead in the wireless ad-hoc data communication system (piconet), instead of 8-octet addresses, 1-octet address is allocated to each of the devices. When a new device associates with the piconet, the piconet coordinator broadcasts a beacon containing information regarding the existing devices and the new device to all of the devices associated with the piconet. Broadcasting of the beacon provides the new device with information regarding the existing devices and allows the existing devices to recognize the new device. When a device requests to disassociate from the piconet or the piconet coordinator requests a dissociation of the device from the piconet, the device must undergo a disassociation process.

FIG. 2 is a block diagram illustrating the structure of a piconet superframe according to IEEE 802.15.3 standards.

The timing of the piconet is based on a superframe. The superframe includes three parts, i.e., a beacon, a contention access period, and a channel time allocation period. The beacon is used to set time allocation and transmit management information regarding the piconet. The contention access period is used to transmit command and/or asynchronous data. The channel time allocation period is used to connect a command, an isochronous stream, and asynchronous data. The contention access period uses Carrier Sense Multiple Access with Collision Avoidance (CSMA/CA) for media access, while the channel time allocation period uses Time Division Multiple Access (TDMA) for the media access. The channel time allocating period includes management channel time allocation slots (MCTAs), which are used for communication between the piconet coordinator and the devices, and channel time allocation slots (CTAs) which are for communication among the devices.

FIG. 3 illustrates a process of associating a device with the piconent according to IEEE 802.15.3 standards. Referring to FIG. 3, a first device transmits a first association request command to a piconet coordinator to request an allocation of an ID. When the piconet coordinator receives the first association request command from the first device, the piconet coordinator transmits a first immediate acknowledgement (ACK) to the first device indicating that the first association request command has been properly received, allocates a device ID to the first device, and transmits an association response command which includes the device ID, to the first device. Thereafter, the first device receives the first immediate acknowledgement (ACK) and the association response command from the piconet coordinator and transmits a second association request command to the piconet coordinator that indicates that the device ID has been properly allocated to the first device. The piconet coordinator transmits a second immediate acknowledgement (ACK) to the first device indicating that the second association request command has been properly received. When the first device receives the second immediate ACK from the piconet coordinator, it is determined that the first device has associated with the piconet. The piconet coordinator then broadcasts a beacon that includes the device ID to all devices associated with the piconet. After all devices associated with the piconet receive the beacon, they become aware of the association of the first device with the piconet. As illustrated in FIG. 3, Device Management Entities (DMEs) manage devices, and MAC Layer Management Entities (MLMEs) manage MAC layers. According to IEEE 802.15.3 standards, communications within the piconet can be achieved via the MLMEs.

FIG. 4 illustrates a process of disassociating a device from the piconet, according to IEEE 802.15.3 standards.

In order to maintain association with the piconet, all devices must transmit frames to the piconet coordinator within a predetermined period of time, i.e., an Association Timeout Period (ATP). If the piconet coordinator does not receive a frame from a device within the ATP, the piconet coordinator disassociates the device from the piconet. In particular, devices in an Asynchronous Power Save (APS) mode must transmit frames to the piconet coordinator within the ATP to maintain their association with the piconet and prevent their disassociation from the piconet.

Referring to FIG. 4, when the piconet coordinator does not receive a frame from the first device within the ATP, the piconet coordinator transmits a disassociation request command which includes the device ID, to the first device. The first device receives the disassociation request command from the piconet coordinator and transmits an immediate ACK to the piconet coordinator that indicates that the disassociation request command has been properly received. When the piconet coordinator receives the immediate ACK, the piconet coordinator determines that the first device has disassociated from the piconet and broadcasts a beacon with the device ID to all devices associated with the piconet. When the devices receive the beacon, the devices become aware of the disassociation of the first device from the piconet. As previously described with reference to FIG. 3, DMEs manage the devices, and MLMEs manage MAC layers.

As described above, association and disassociation processes according to IEEE 802.15.3 require the exchange of many frames between devices and a piconet coordinator, resulting in wasting an effective period and producing extra overhead.

### SUMMARY OF THE INVENTION

The present invention provides a system and method for managing the association of a device with a piconet in which the devices remain associated with the piconet without transmitting frames to a piconet coordinator for a long period of time.

According to an aspect of the present invention, there is provided an apparatus that associates devices with a piconet. The apparatus includes an association device list updater, which updates an association device list of a first device by referring to an association device list, on which the devices associated with the piconet are registered and association elapsed periods of the devices are recorded; an association elapsed period extractor, which, when the first device requests communication with a second device registered on the updated association device list, extracts an association elapsed period of the second device from the updated association device list; and an inter-device communicator, which, if the extracted association elapsed period is shorter than an association timeout period, performs the communication between the first and second devices.

According to another aspect of the present invention, there is provided an apparatus that coordinates associations of devices with a piconet. The apparatus includes a second association request command receiver, which receives, from a first device, a second association request command that indicates that a device ID has been properly allocated to the first device; an initial association elapsed period setter, which, when the second association request command receiver receives the second association request command, sets an association elapsed period of the first device to an initial value; and an association device list maker which registers the first device and records the set association elapsed period on an association device list so that the set association elapsed period corresponds to the first device.

According to still another aspect of the present invention, there is provided a system that manages associations of devices with a piconet. The system includes a piconet-device association coordinator, which receives, from a first device, a second association request command that indicates a proper allocation of a device ID to the first device, sets an association elapsed period of the first device to an initial value, and registers the first device and records the association elapsed period to an association device list so that the first device corresponds to the association elapsed period; and a piconet-device associator, which updates an association device list of the first device by referring to the association device list, extracts an association elapsed period of a second device registered on the updated association device list from the updated association device list when the first device requests communication with the second device, and performs the communication between the first and second devices if the extracted association elapsed period is shorter than an association timeout period.

According to yet another aspect of the present invention, there is provided a method of associating devices with a piconet. The method involves updating an association device list of a first device by referring to an association device list, on which the devices associated with the piconet are registered and association elapsed periods of the devices are recorded; if the first device requests communication with a second device registered on the updated association device list, extracting an association elapsed period of the second device from the updated association device list; and if the extracted association elapsed period is shorter than an association timeout period, performing the communication between the first and second devices.

According to yet another aspect of the present invention, there is provided a method of coordinating associations of devices with a piconet. The method involves receiving, from a first device, a second association request command that indicates that a device ID has been properly allocated to the first device; if the second association request command is received, setting an association elapsed period of the first device to an initial value; and registering the first device and recording the set association elapsed period to an association device list so that the set association elapsed period corresponds to the first device.

According to yet another aspect of the present invention, there is provided a method of managing associations of devices with a piconet. The method involves receiving, from a first device, a second association request command that indicates that a device ID has been properly allocated to the first device, setting an association elapsed period of the first device, and registering the first device and recording the set association elapsed period to an association device list so that the first device corresponds to the set association elapsed period; and updating the association device list of the first device by referring to the association device list, extracting an association elapsed period of a second device registered on the updated association device list from the updated association device list if the first device requests communication with the second device, and performing the communication between the first and second devices if the extracted association elapsed period is shorter than an association timeout period.

According to yet another aspect of the present invention, there is provided a beacon frame. The beacon frame includes a field in which devices associated with a piconet are registered and association elapsed periods of the devices are recorded.

According to yet another aspect of the present invention, there is provided a device information command frame. The device information command frame includes a field that comprises a value that indicates that a predetermined device does not associate with a piconet. Here, the predetermined device being registered on an association device list on which devices associated with the piconet are registered and association elapsed periods of the devices are recorded.

According to yet another aspect of the present invention, there is provided a peer information command frame. The peer information command frame includes a field that comprises a value that informs a piconet coordinator that communication between devices associated with a piconet has ended. Here, the piconet coordinator manages the piconet.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of a piconet according to IEEE 802.12.3 standards;

FIG. 2 is a block diagram illustrating the structure of a piconet superframe according to IEEE 802.15.3 standards;

FIG. 3 illustrates a process of associating a device with the piconent, according to IEEE 802.15.3 standards;

FIG. 4 illustrates a process of disassociating a device from the piconet, according to IEEE 802.15.3 standards;

FIG. 5 illustrates the structure of a system that manages associations of devices with a piconet, according to a first embodiment of the present invention;

FIG. 6 illustrates the structure of an MAC header according to IEEE 802.15.3;

FIG. 7 illustrates the structure of an association request command according to IEEE 802.15.3;

FIG. 8 illustrates the structure of an immediate ACK according to IEEE 802.15.3;

FIG. 9 illustrates the structure of an association response command according to IEEE 802.15.3;

FIG. 10 illustrates the structure of a beacon according to IEEE 802.15.3;

FIG. 11A illustrates the structure of an information element field according to a second embodiment of the present invention;

FIG. 11B illustrates the structure of an association device list field included in the information element field of FIG. 11A;

FIG. 12 illustrates the structure of a probe request command according to IEEE 802.15.3;

FIG. 13 illustrates the structure of a probe response command according to IEEE 802.15.3;

FIG. 14 illustrates the structure of a device information command according to the second embodiment of the present invention;

FIG. 15 illustrates the structure of a peer information command, according to the second embodiment of the present invention;

FIG. 16 illustrates a process of maintaining associations of devices with a piconet according to a third embodiment of the present invention;

FIGS. 17A and 17B are flowcharts illustrating a method of associating a device with a piconet according to the third embodiment of the present invention; and

FIG. 18 is a flowchart illustrating a method of coordinating an association of a device with a piconet according to a fourth embodiment of the present invention.

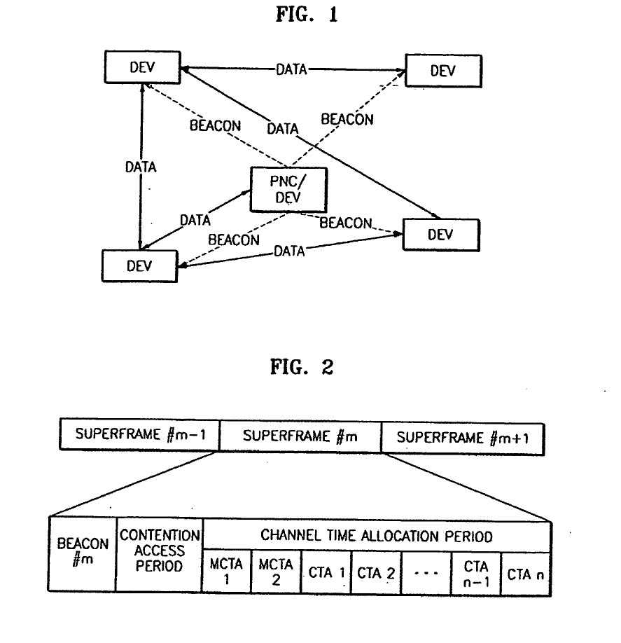

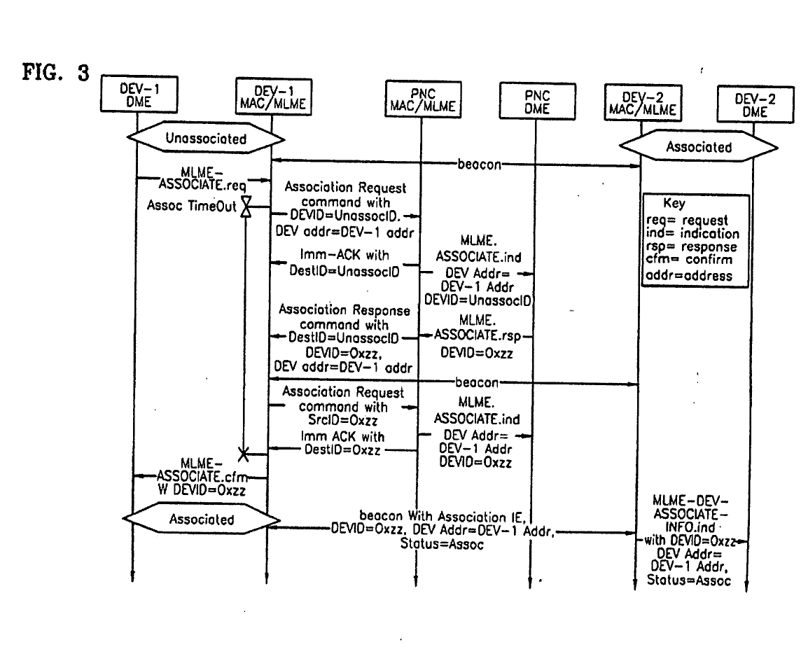

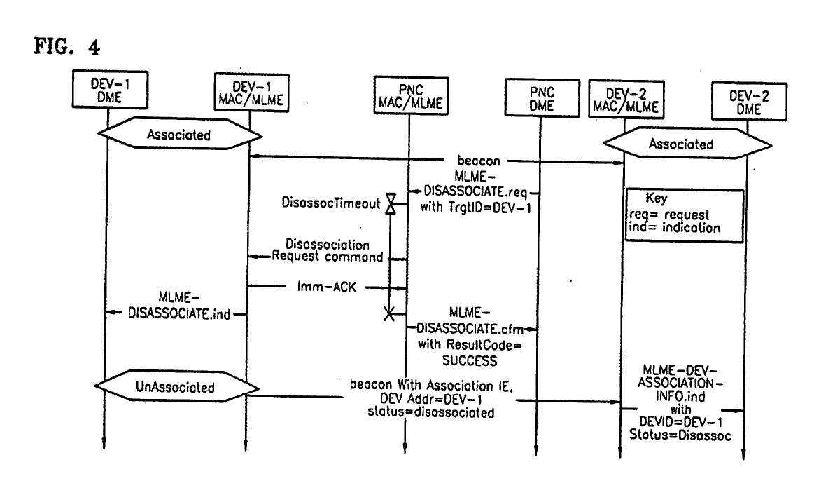

### DETAILED DESCRIPTION OF THE INVENTION

Hereinafter, preferred embodiments of the present invention will be described in detail with reference to the attached drawings.

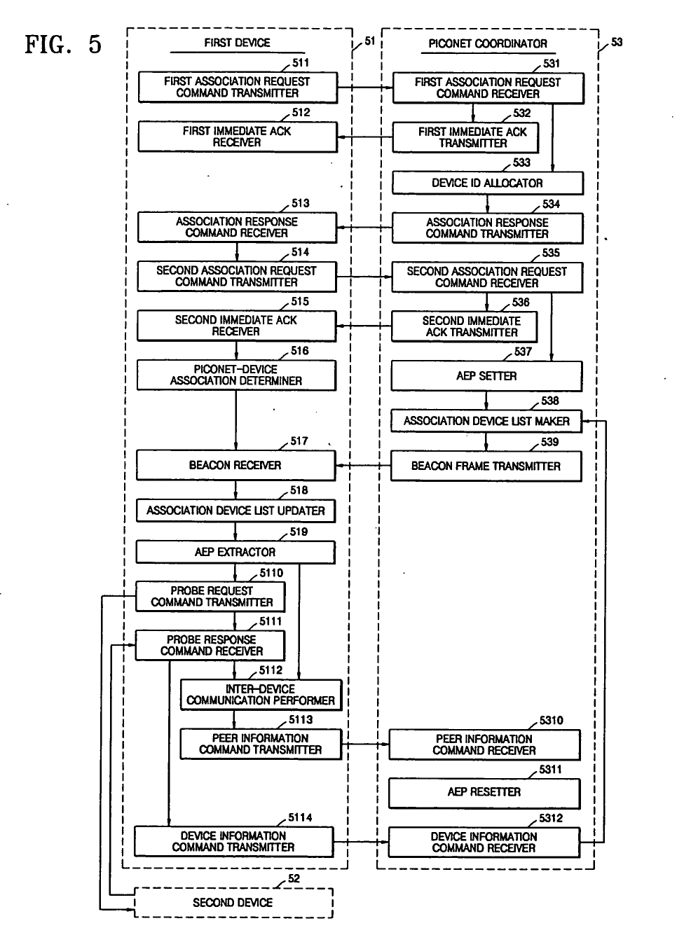

FIG. 5 is a block diagram illustrating the structure of a system that manages associations of devices with a piconet according to a first embodiment of the present invention. Referring to FIG. 5, the system includes a first device 51 (which can also be called a piconet device associator) and a piconet coordinator 53 (which can also be called a piconet device association coordinator).

The piconet coordinator 53 receives a second association request command from the first device 51 that indicates that a device ID has been properly allocated to the first device 51. Next, the piconet coordinator 53 sets an association elapsed period (AEP) of the first device 51 to an initial value, registers the first device, and records the set AEP on an association device list corresponding to the set AEP.

The first device 51 updates the association device list of the first device 51 by referring to the association device list registered and recorded by the piconet coordinator 53. For a communication between the first device and a second device 52 registered is the association device list, the first device 51 extracts an AEP of the second device 52 from the updated association device list. If the extracted AEP is shorter than an ATP, the first device 51 performs the communication with the second device 52.

A piconet device association apparatus 51 includes a first association request command transmitter 511, a first immediate ACK receiver 512, an association response command receiver 513, a second association request command transmitter 514, a second immediate ACK receiver 515, a piconet device association determiner 516, a beacon receiver 517, an association device list updater 518, an AEP extractor 519, a probe request command transmitter 5110, a probe response command receiver 5111, an inter-device communicator 5112, a peer information command transmitter 5113, and a device information command transmitter 5114.

A piconet device association coordination apparatus 53 includes a first association request command receiver 531, a first immediate ACK transmitter 532, a device ID allocator 533, an association response command transmitter 534, a second association request command receiver 535, a second immediate ACK transmitter 536, an AEP setter 537, an association device list maker 538, a beacon frame transmitter 539, a peer information command receiver 5310, an AEP resetter 5311, and a device information command receiver 5312.

FIG. 6 illustrates the structure of MAC header according to IEEE 802.15.3. Referring to FIG. 6, the MAC header includes 10 octets, and is added to a front portion of each frame transmitted within the piconet. The MAC header includes a frame type field, which indicates a type of frame, a source ID field, which indicates a source ID of a received frame, and a destination ID field, which indicates a destination ID of the received frame.

The first association request command transmitter 511 of the first device 51 transmits a first association request command to the piconet coordinator 53 to request an allocation of a device ID to the first device 51. The first association request command receiver 531 of the piconet coordinator 53 receives the first association request command from the first device 51.

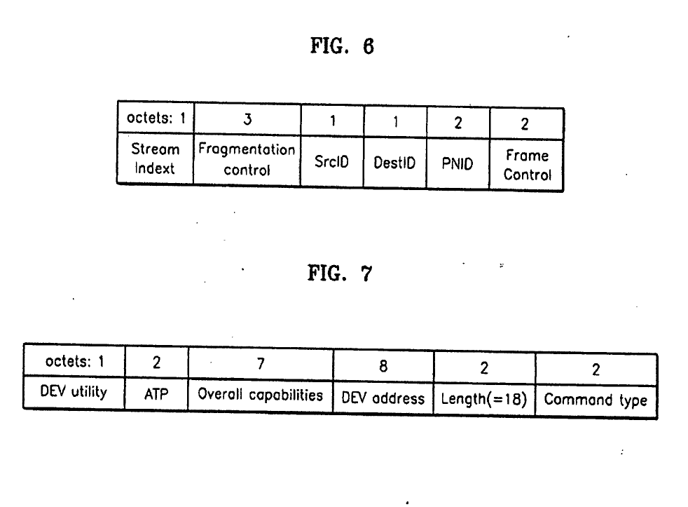

FIG. 7 illustrates the structure of an association request command according to IEEE 802.15.3. Referring to FIG. 7, the MAC header of FIG. 6 is added to the association request command of FIG. 7. The association request command includes a source ID field with an unassociated ID, a destination ID field with a piconet coordinator ID, and a device address field with an address of a device transmitting the association request command. In other words, when a source ID is an unassociated ID, it means the device does not have an ID and requests an allocation of an ID to the device with the address recorded in the device address field.

When the first association request command receiver 531 receives the first association request command, the first immediate ACK transmitter 532 of the piconet coordinator 53 transmits a first immediate ACK to the first device 51 that indicates that the first association request command has been properly received. The first immediate ACK receiver 512 of the first device 51 receives the first immediate ACK from the piconet coordinator 53.

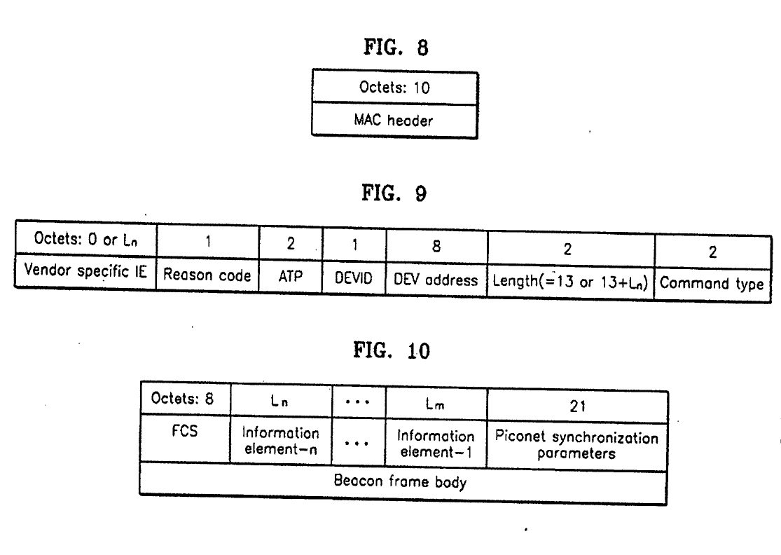

FIG. 8 illustrates the structure of an immediate ACK according to IEEE 802.15.3. Referring to FIG. 8, the immediate ACK includes a MAC header and informs a device that a piconet coordinator has properly received a frame transmitted by the device immediately before the immediate ACK was received by the device. In other words, when the first device 51 transmits a first association request frame and then receives the first immediate ACK, the first device 51 can determine that the piconet coordinator 53 has properly received the first association request frame.

When the first association request command receiver 531 receives the first association request command, the device ID allocator 533 of the piconet coordinator 53 allocates a device ID to the first device 51. The association response command transmitter 534 of the piconet coordinator 53 transmits an association response command, which includes the device ID, to the first device 51. The association response command receiver 513 receives the association response command from the piconet coordinator 53.

FIG. 9 illustrates the structure of an association response command according to IEEE 802.15.3. Referring to FIG. 9, the MAC header of FIG. 6 is added to the association response command of FIG. 9. The association response command includes a source ID field with a piconet coordinator ID, a destination ID field with an unassociated ID, and a device ID field with a device ID Qxzz that is allocated by the piconet coordinator 53. In other words, when the destination ID is the unassociated ID and a device ID is recorded in the device ID field, then the recorded device ID is a newly allocated ID.

The second association request command transmitter 514 of the first device 51 transmits a second association request command to the piconet coordinator 53 to indicate that the device ID of the association response command has been properly allocated to the first device 51. The second association request command receiver 535 of the piconet coordinator 53 receives the second association request command. When the first device 51 receives the association response command, the first device 51 transmits the second association request command to the piconet coordinator 53 which informs the piconet coordinator 53 of the proper allocation of the device ID. Here, a source ID field of the second association request command includes the newly allocated device ID Qxzz.

When the second association request command receiver 535 receives the second association request command, the second immediate ACK transmitter 536 of the piconet coordinator 53 transmits a second immediate ACK to the first device 51 which indicates that the second association request command has been properly received. The second immediate ACK receiver 515 of the first device 51 receives the second immediate ACK from the piconet coordinator 53. Here, like the first immediate ACK, the second immediate ACK includes an MAC header, which informs a device that a piconet coordinator has properly received a frame transmitted by the device immediately prior to the reception of the second immediate ACK by the device. In other words, when the first device 51 transmits the second association request command and then receives the second immediate ACK, the first device 51 can determine that the piconet coordinator has properly received the second association request command.

When the second immediate ACK receiver 516 receives the second immediate ACK, the piconet device association determiner 516 of the first device 51 determines that the first device 51 has associated with the piconet. To be more specific, when the first device 51 receives the second immediate ACK, the first device 51 can determine that the piconet coordinator 53 has properly received the second association request command. Here, an MLME of the first device 51 informs a DME of the first device 51 that the device ID has been allocated to the first device 51, and the DME of the first device 51 determines that the first device 51 has associated with the piconet.

When the second association request command receiver 535 receives the second association request command, the AEP initializer 537 sets an AEP of the first device 51 to an initial value, i.e., “0”. An IEEE 802.15.3 ATP according to the present invention refers to a critical period during which devices associate with a piconet in spite of their movements, breakdowns, and so forth. However, when the piconet coordinator 53 does not receive a frame from a device within the existing IEEE 802.15.3 ATP, the piconet coordinator 53 disassociates the device from the piconet. The disassociated device must undergo an association process again to re-associate with the piconet. This results in loss of channel resources in a wireless communication environment in which channels are limited and there are many frames exchanged among devices. In order to solve these problems, the first embodiment of the present invention employs the AEP as a new information element. The AEP refers to an elapsed period after an instant in time when a device associates with the piconet. More broadly, the AEP refers to an elapsed period after an instant in time when a device informs the piconet that the device has associated with the piconet. When the piconet coordinator 53 receives the second association request command from the first device 51, the piconet coordinator 53 determines that the first device 51 has associated with the piconet. Thus, the AEP of the first device 51 is set to the initial value, i.e., “0”. Devices associated with the piconet increase their AEPs using their local clocks. If an AEP of a device is shorter than an ATP, i.e., it can be assumed that the device has associated with the piconet, the device can immediately communicate with another device. However, if the AEP of the device is not shorter than the ATP, i.e., it cannot be assumed that the device has associated with the piconet, the device must undergo another process.

The association device list maker 538 of the piconet coordinator 53 registers the first device and records the set AEP on the association device list so as to correspond to the set AEP. The beacon transmitter 539 of the piconet coordinator 53 broadcasts a beacon which includes the association device list. The beacon receiver 517 of the first device 51 receives the beacon from the piconet coordinator 53. Thus, all devices associated with the piconet receive the beacon. As a result, the first device 51, the second device 52, and other devices associated with the piconet perceive that the first device 51 has re-associated with the piconet and the AEP has a value of “0”. Thereafter, when both a device that requests a communication with the first device 51 and the first device 51 have associated with the piconet within the AEP, the device can immediately communicate with the first device 51.

FIG. 10 illustrates the structure of a beacon according to IEEE 802.15.3. Referring to FIG. 10, the beacon includes as many information element fields as devices associated with the piconet. Information for managing the devices associated with the piconet is recorded in the information element fields.

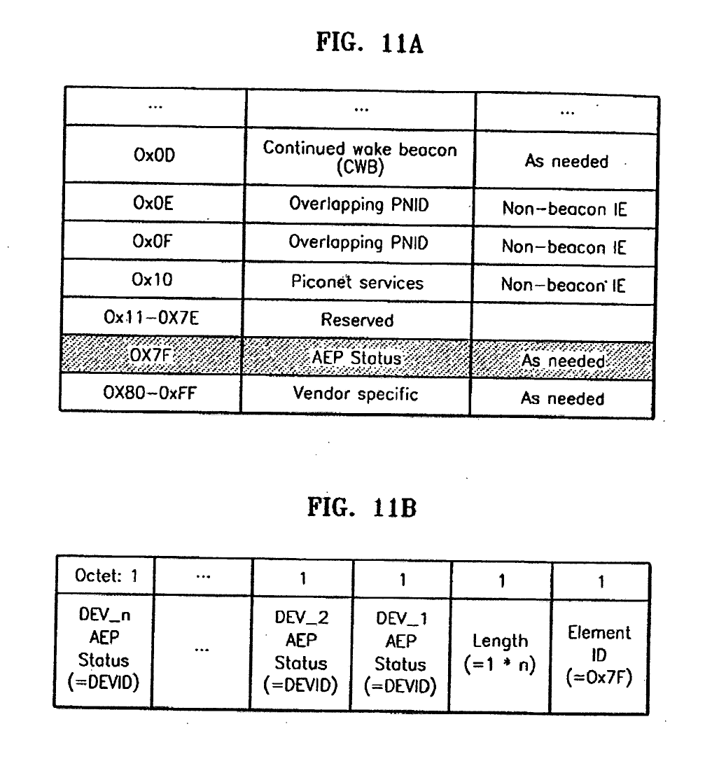

FIG. 11A illustrates the structure of the information element field of FIG. 10. Referring to FIG. 11A, according to IEEE 802.15.3 standards, address 0x7F of the beacon is reserved. According to the second embodiment of the present invention, 0x7F of the beacon is used as an association device list field. The association device list field registers the devices and the AEPs of the devices so that the devices correspond to the AEPs.

FIG. 11B illustrates the structure of the association device list field of FIG. 11A. Referring to FIG. 11B, the association device list field includes an element ID field, a length field, and AEP fields of the devices. The association device list field registers the AEP of the first device 51 and AEPs of other devices that have already associated with the piconet. Since the first device 51 is a newly associated device, the AEP field of the first device 51 registers a value of “0”. The AEP fields of the devices that have already associated with the piconet register AEPs at instants in time when the other devices associate with the piconet. As previously described, an AEP refers to the elapsed period after the instant in time when a device informs the piconet coordinator 53 that the device has associated with the piconet. An AEP of the device is set to an initial value, i.e., “0”, at the instant in time when a device informs the piconet coordinator 53 that the device has associated with the piconet. The AEP of the device increases using a local clock of the piconet coordinator 53. The piconet coordinator 53 increases AEPs of other devices associated with the piconet using its local clock and checks current states of the other devices. The piconet coordinator 53 periodically informs all devices associated with the piconet of their current state, i.e., of whether the devices are associated with the piconet. The devices associated with the piconet can accurately determine current states of other devices by receiving information elements from the piconet coordinator 53. As a result, the devices can-reliably communicate with other devices. In particular, in a case of a device newly associated with the piconet, the device does not include information on existing devices associated with the piconet. However, since the device can receive information elements from the piconet coordinator 53, the device can determine current states of the other devices. As a result, the device can reliably communicate with the other devices.

The association device list updater 518 of the first device 51 updates the association device list of the first device 51 by referring to the association device list of the beacon. In other words, the association device list updater 518 updates the association device list of the first device 51 by referring to the association device list on which devices associated with the piconet are registered and AEPs of the devices are recorded. When the first device 51 receives a beacon frame from the piconet coordinator 53, the beacon frame includes updated information regarding the devices associated with the piconet. Each of the devices may have its own association device list and check its current AEP using its own local clock. This does not consider several conditions such as possible movements, breakdowns, and so on of the devices associated with the piconet. When a device informs the piconet coordinator 53 that the device is properly operating within the piconet, the piconet coordinator 53 must reset an AEP of the device to an initial value. However, this is also not considered. Thus, when the devices receive the beacon, they must update their association device lists by referring to updated information contained in the beacon, i.e., updated association device lists.

When the first device 51 requests communication with the second device 52, which is registered in the updated association device list, the AEP extractor 519 of the first device 51 extracts an AEP of the second device 52 from the updated association device list. More specifically, when the first device 51 requests the communication with the second device 52, the AEP extractor 519 must determine whether the second device 52 has associated with the piconet. In other words, the AEP extractor 519 extracts the AEP of the second device 52 from the association device list.

When the extracted AEP is shorter than the ATP, i.e., it can be assumed that the second device 52 has associated with the piconet, the inter-device communicator 5112 (FIG. 5) of the first device 51 performs the communication between the first device 51 and the second device 52.

If the extracted AEP is not shorter than the ATP, i.e., it cannot be assumed that the second device 52 has associated with the piconet, the probe request command transmitter 5110 of the first device 51 performs a peer discovery process according to IEEE 802.15.3 standards. In other words, the probe request command transmitter 5110 transmits a probe request command to the second device 52 to request confirmation regarding whether the second device 52 has associated with the piconet.

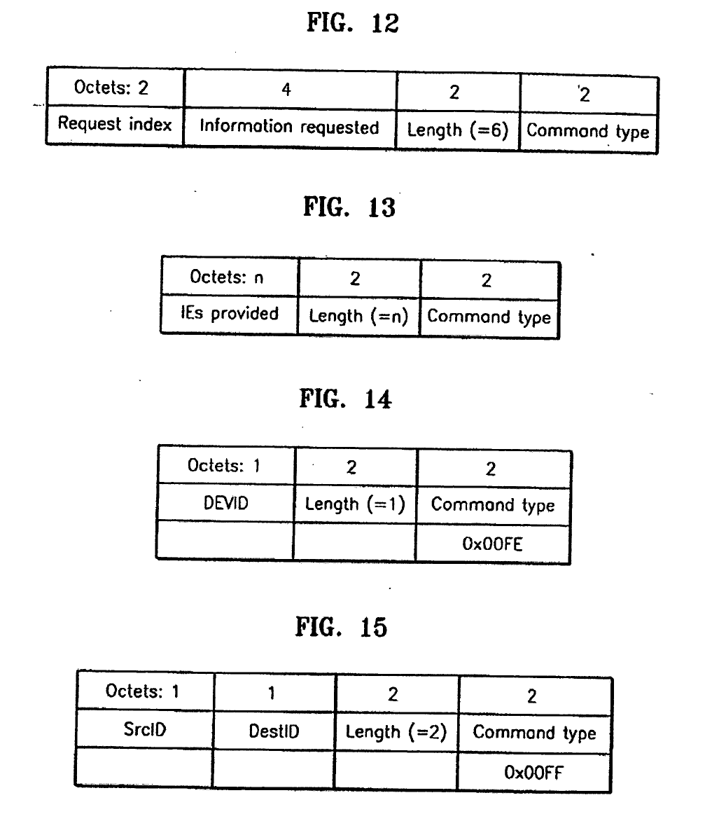

FIG. 12 illustrates the structure of the probe request command according to IEEE 802.15.3. Referring to FIG. 12, the probe request command includes a command type field, a length field, an information requested field, and a request index field.

The probe response command receiver 5111 of the first device 51 receives a probe response command from the second device 52 that indicates that the second device 52 has associated with the piconet.

FIG. 13 illustrates the structure of a probe response command according to IEEE 802.15.3. Referring to FIG. 13, the probe response command includes a command type field, a length field, and an information element provided field. When an ID of the second device 52 that is searched for is recorded in the information element provided field, the first device 51 can determine based on the ID of the second device 52, that the second device 52 has associated with the piconet.

When the probe response command receiver 5111 receives the probe response command, the inter-device communicator 5112 of the first device 51 performs the communication between the first device 51 and the second device 52. Here, the reception of the probe response command indicates that the second device 52 is properly operating within the piconet. Therefore, the first device 51 can immediately communicate with the second device 52.

When the probe response command receiver 5111 does not receive the probe response command, the device information command transmitter 5114 of the first device 51 transmits a device information command to the piconet coordinator 53 that indicates that the second device 52 which is registered on the association device list, is not associated with the piconet or cannot associate with the piconet due to a breakdown.

The device information command receiver 5312 of the piconet coordinator 53 receives the device information command from the first device 51.

When the device information command receiver 5312 receives the device information command, the association device list maker 538 of the piconet coordinator 53 deletes the second device 52 from the association device list. The device information command has newly been suggested in the present invention.

FIG. 14 illustrates the structure of a device information command according to the second embodiment of the present invention. Referring to FIG. 14, the device information command includes a command type field, a length field, and a device ID field. A command type is set to 0x00FE, which is a reserved command. When the piconet coordinator 53 receives the command 0X00FE recorded in the command type field, the piconet coordinator 53 determines that a device with a device ID recorded in the device ID field has disassociated with the piconet. Here, the piconet coordinator 53 deletes the device with the device ID from the association device list and broadcasts the beacon to all devices associated within the piconet to inform them of the deletion. Each of the devices updates its own association device list and cancels communication with the deleted device. To re-associate with the piconet, the deleted device must again undergo the above-described association process. This re-association process replaces an existing IEEE 802.15.3 disassociation process which requires exchanges of frames. In the second embodiment of the present invention, such a disassociation process is omitted.

When the inter-device communicator 5112 terminates the communication between the first device 51 and the second device 52, the peer information command transmitter 5113 of the first device 51 transmits a peer information command to the piconet coordinator 53 that indicates that the communication between the first device 51 and the second device 52 has ended. The peer information command receiver 5310 of the piconet coordinator 53 receives the peer information command from the first device 51, and the AEP resetter 5311 of the piconet coordinator 53 resets the AEPs of the first device 51 and the second device 52 to initial values. The association device list maker 538 of the piconet coordinator 53 records the reset AEPs of the first device 51 and the second device 52 in the association device list. The peer information command has been newly suggested in the present invention.

FIG. 15 illustrates the structure of a peer information command according to the second embodiment of the present invention. Referring to FIG. 15, the peer information command includes a command type field, a length field, a destination ID field, and a source ID field. A command type is set to 0x00FF, which is a reserved command. If the first device 51 finishes transmitting data to the second device 52, the first device 51 transmits a peer information command to the piconet coordinator 53, which includes the command type field including the command 0x00FF, a destination ID field including an ID of the second device 52, and a source ID field including an ID of the first device. The piconet coordinator 53 determines, by receiving the peer information command, that the first and second devices 51 and 52 have associated with the piconet, and resets the AEPs of the first devices 51 and 52 for possible communication of the first device 51 with the second device 52. The piconet coordinator 53 records the reset AEPs of the first and second devices 51 and 52 in the association device list and broadcasts a beacon to all devices associated with the piconet to inform them of the recording. Each of the devices updates its association device list. Also, as previously described, a device which requests a communication with the first device 51 or the second device 52 can immediately communicate with the first device 51 or the second device 52 prior to the ATP.

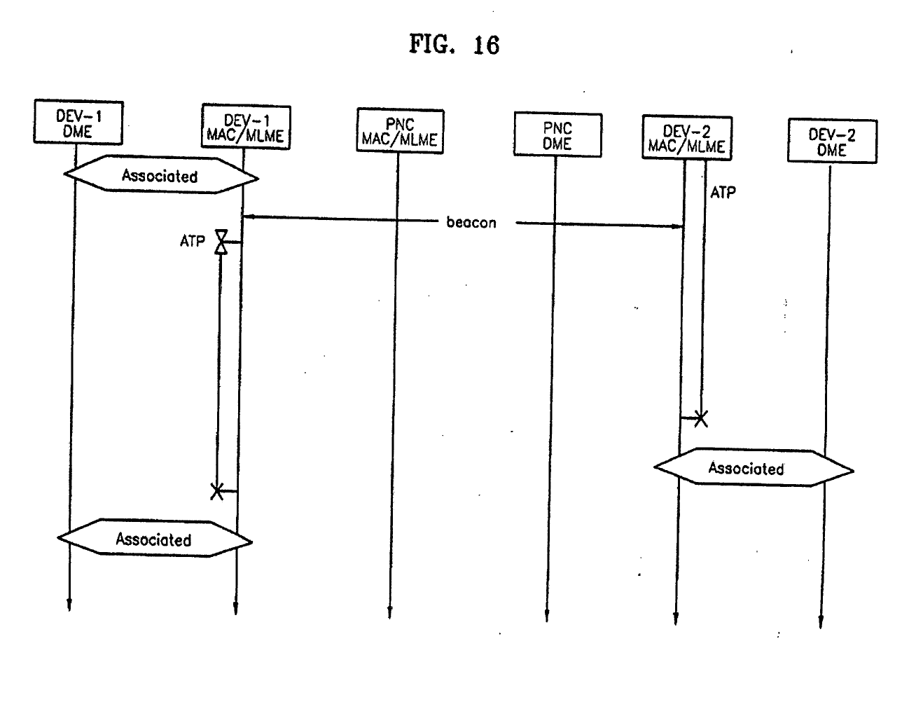

FIG. 16 illustrates a process of maintaining associations of devices with a piconet according to a third embodiment of the present invention. Referring to FIG. 16, a first device receives a beacon with a reset AEP of the first device from a piconet coordinator. The first device increases the AEP using its local clock from this instant in time. The first device stays associated with a piconet for an ATP. If the first device receives the beacon with the AEP before the ATP elapses, the first device maintains association with the piconet, and the above process is repeated. However, when the first device does not receive the beacon before the ATP elapses, the first device performs an IEEE 802.15.3 peer discovery process and determines, based on the result of the IEEE 802.15.3 peer discovery process, whether the first device has associated with the piconet.

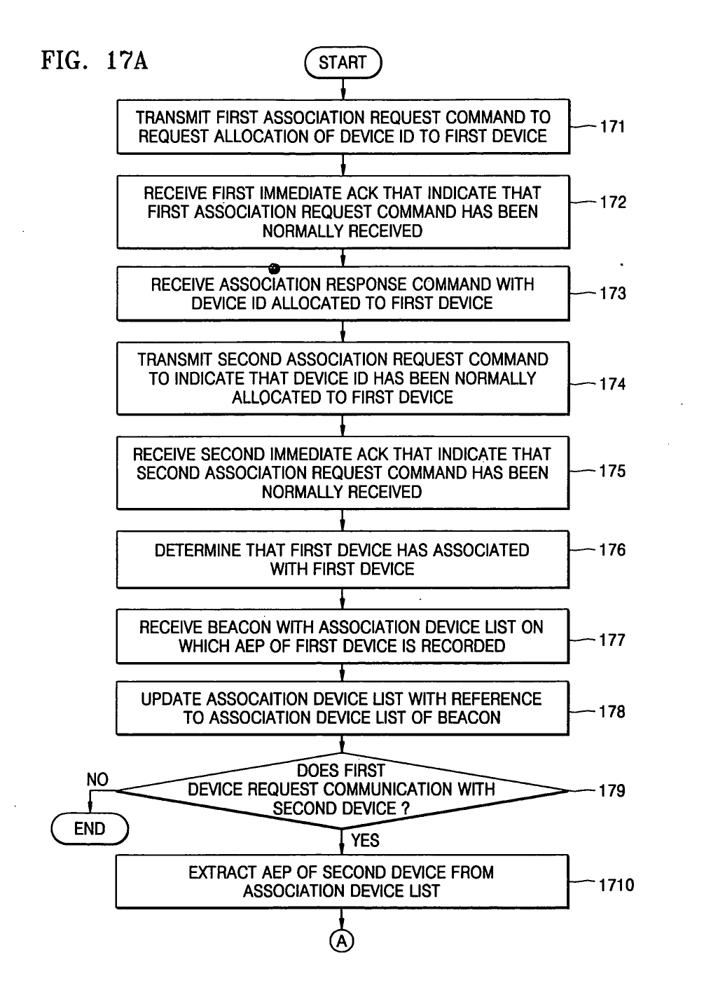

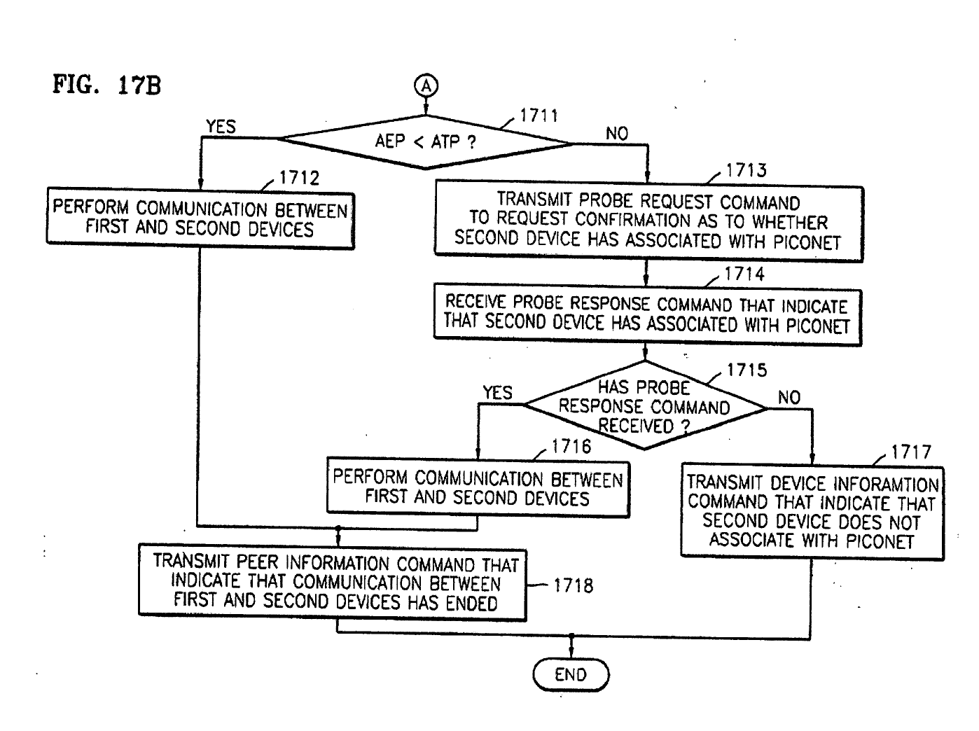

FIGS. 17A and 17B are flowcharts illustrating a method of associating a device with a piconet according to the third embodiment of the present invention. Referring to FIGS. 17A and 17B, in step 171, a first device associated with a piconet transmits a first association request command to a piconet coordinator, which manages the piconet, to request an allocation of a device ID to the first device. In step 172, the first device receives a first immediate ACK from the piconet coordinator that indicates that the first association request command has been properly received. In step 173, the first device receives an association response command with the device ID allocated to the first device from the piconet coordinator. In step 174, the first device transmits a second request command to the piconet coordinator that indicates that the ID of the association response command has been properly allocated to the first device. In step 175, the first device receives a second immediate ACK from the piconet coordinator that indicates that the second association request command has been properly received. In step 176, the first device determines that the first device has associated with the piconet. In step 177, the first device receives a beacon including an association device list from the piconet coordinator, on which an AEP of the first device has been recorded. In step 178, the first device updates its association device list by referring to the association device list of the beacon. In other words, the first device updates its association device list by referring to an association device list, on which a device associated with the piconet has been registered and an AEP of the device have been recorded. In step 179, a determination is made as to whether the first device requests communication with a second device registered on the updated association device list. If, in step 179, it is determined that the first device has requested the communication with the second device, then the first device extracts an AEP of the second device from the updated association device list, in step 1710. In step 1711, a determination is made as to whether the extracted AEP is shorter than an ATP. If, in step 1711, it is determined that the extracted AEP is shorter than the ATP, then the first device performs the communication with the second device in step 1712. If, in step 1711, it is determined that the extracted AEP is not shorter than the ATP, the first device transmits a probe request command to the second device to request confirmation regarding whether the second device has associated with the piconet, in step 1713. In step 1714, the first device receives a probe response command from the second device that indicates that the second device has associated with the piconet. In step 1715, a determination is made as to whether the first device has properly received the probe response command. If, in step 1715, it is determined that the first device has properly received the probe response command, then the first device performs the communication with the second device, in step 1716. If, in step 1715, it is determined that the first device has not properly received the probe response command, then the first device transmits a device information command to the piconet coordinator that indicates that the second device does not associate with the piconet, in step 1717. In step 1718, the first device transmits a peer information command to the piconet coordinator that indicates that the communication with the second device has ended.

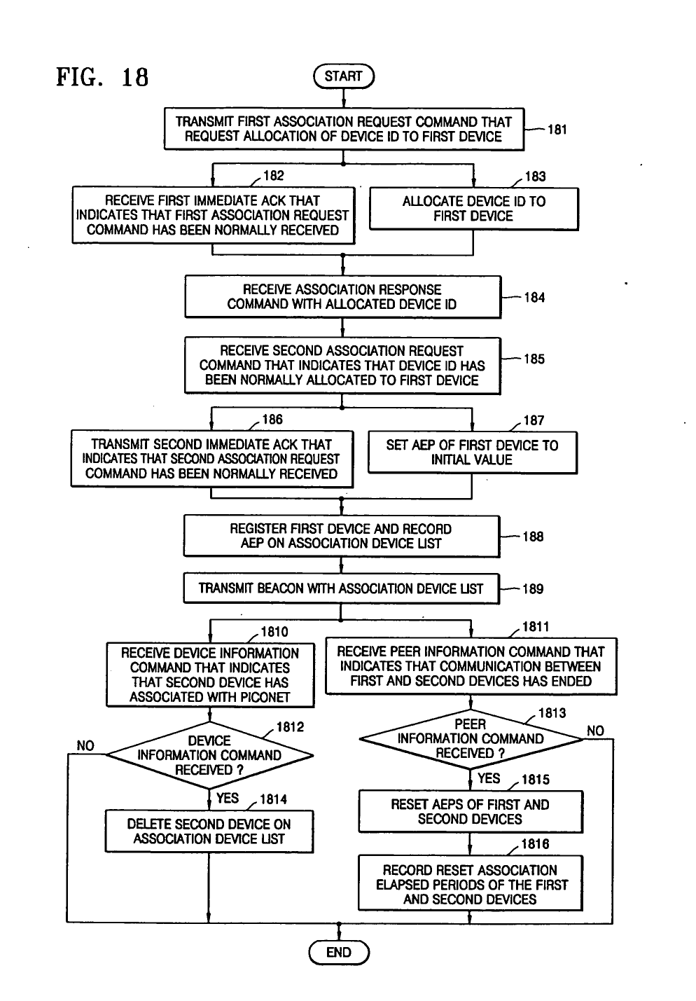

FIG. 18 is a flowchart illustrating a method of managing an association of a device with a piconet according to a fourth embodiment of the present invention. Referring to FIG. 18, in step 181, a piconet coordinator receives a first association request command from a first device to request an allocation of a device ID to the first device. In step 182, the piconet coordinator transmits a first immediate ACK to the first device that indicates that the first association request command has been properly received. In step 183, the piconet coordinator allocates the device ID to the first device. In step 184, the piconet coordinator transmits an association response command including the device ID allocated to the first device. In step 185, the piconet coordinator receives a second association request command from the first device that indicates the proper allocation of the device ID to the first device. In step 186, the piconet coordinator transmits a second immediate ACK to the first device that indicates that the second association request command has been properly received. In step 187, the piconet coordinator sets an AEP of the first device to an initial value. In step 188, the piconet coordinator registers the first device and records the set AEP on an association device list so that that the set AEP corresponds to the first device. In step 189, the piconet coordinator broadcasts a beacon including the association device list. In step 1810, the piconet coordinator receives a device information command from the first device that indicates that the second device does not associate with the piconet. In step 1812, a determination is made as to whether the piconet coordinator has properly received the device information command. If, in step 1812, it is determined that the piconet coordinator has properly received the device information command, then the piconet coordinator deletes the second device from the association device list, in the step 1814. In step 1811, the piconet coordinator receives a peer information command from the first device that indicates that the communication between the first and second devices has ended. In step 1813, a determination is made as to whether the piconet coordinator has properly received the peer information command. If, in step 1813, it is determined that the piconet coordinator has properly received the peer information command, then the AEP of the first device and an AEP of the second device are reset to initial values, in step 1815. In step 1816, the AEPs of the first and second devices are recorded.

As described above, in an apparatus and method for managing associations of devices with a piconet according to exemplary embodiments of the present invention, an AEP can be introduced as a new information element. Thus, devices can remain associated with the piconet without transmitting frames to a piconet coordinator for a long period of time. That is, devices in an asynchronous power save mode can maintain their membership in the piconet so that they can remain associated with the piconet without periodically transmitting frames to the piconet coordinator within an ATP. As a result, existing disassociation and re-association processes are not required, thereby limiting the number of unnecessary exchanges of the frames. Therefore, the piconet coordinator and the devices can secure effective periods, and a load on the system can be reduced.

The exemplary embodiments of the present invention can be embodied as a computer-executable program on a computer-readable recording medium and then executed in a general-purpose computer.

Also, a data structure used to perform the method according to exemplary embodiments of the present invention can be recorded on the computer-readable recording medium using several means.

The computer-readable recording medium includes storage media such as magnetic storage media (e.g., ROMs, floppy disks, hard disks, etc.), optically readable media (e.g., CD-ROMs, DVDs, etc.) and carrier waves (e.g., transmissions over the Internet).

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An apparatus that associates devices with a piconet, the apparatus comprising:
an association device list updater, which updates an association device list of a first device by referring to an association device list, on which the devices associated with the piconet are registered and association elapsed periods of the devices are recorded;
an association elapsed period extractor, which, when the first device requests communication with a second device registered on the updated association device list, extracts an association elapsed period of the second device from the updated association device list; and
an inter-device communicator, which, if the extracted association elapsed period is shorter than an association timeout period, performs the communication between the first and second devices.

2. The apparatus of claim 1, further comprising:
a beacon receiver, which receives a beacon that comprises the association device list from a piconet coordinator, which manages the piconet,
wherein the association device list updater updates the association device list of the first device by referring to the association device list of the beacon.

3. The apparatus of claim 2, further comprising:
a first association request command transmitter, which transmits, to the piconet coordinator a first association request command to request an allocation of a device ID to the first device;
a first immediate ACK receiver which receives, from the piconet coordinator, a first immediate ACK that indicates that the first association request command has been properly received;
an association response command receiver, which receives an association response command that comprises the device ID allocated to the first device from the piconet coordinator;
a second association request command transmitter, which transmits, to the piconet coordinator, a second association request command that indicates the proper allocation of the device ID to the first device; and
a second immediate ACK receiver which receives, from the piconet coordinator, a second immediate ACK that indicates that the second association request command has been properly received.

4. The apparatus of claim 3, further comprising:
a piconet device association determiner, which, if the second immediate ACK receiver receives the second immediate ACK, determines that the first device has associated with the piconet,
wherein the beacon receiver receives, from the piconet coordinator, the beacon with the association device list, on which the association elapsed period of the first device is recorded.

5. The apparatus of claim 1, further comprising:
a probe request command transmitter, which, if the extracted association elapsed period is not shorter than the association timeout period, transmits, to the second device, a probe request command to request confirmation whether the second device has associated with the piconet; and
a probe response command receiver, which receives, from the second device, a probe response command that indicates that the second device has associated with the piconet,
wherein when the probe response command receiver receives the probe response command, the inter-device communication performer performs the communication between the first and second devices.

6. The apparatus of claim 5, further comprising a device information command transmitter, which, when the probe response command receiver does not receive the probe response command, transmits, to the piconet coordinator, a device information command that indicates that the second device does not associate with the piconet.

7. The apparatus of claim 5, further comprising a peer information command transmitter, which, when the inter-device communication performer terminates the communication between the first and second devices, transmits a peer information command to the piconet coordinator that indicates that the communication between the first and second devices has ended.

8. An apparatus that coordinates associations of devices with a piconet, the apparatus comprising:
a second association request command receiver, which receives, from a first device, a second association request command that indicates that a device ID has been properly allocated to the first device;
an initial association elapsed period setter, which, when the second association request command receiver receives the second association request command, sets an association elapsed period of the first device to an initial value; and
an association device list maker which registers the first device and records the set association elapsed period on an association device list so that the set association elapsed period corresponds to the first device.

9. The apparatus of claim 8, further comprising a beacon frame transmitter which broadcasts a beacon with the association device list.

10. The apparatus of claim 8, further comprising:
a first association request command receiver, which receives, from the first device, a first association request command that requests the allocation of the device ID to the first device;
a first immediate ACK transmitter, which, when the first association request command receiver receives the first association request command, transmits, to the first device, a first immediate ACK that indicates that the first association request command has been properly received;
a device ID allocator, which, when the first association request command receiver receives the first association request command, allocates the device ID to the first device;
an association response command transmitter, which transmits an association response command that comprises the device ID to the first device; and
a second immediate ACK transmitter, which, when the second association request command receiver receives the second association request command, transmits, to the first device, a second immediate ACK that indicates that the second association request command has been properly received.

11. The apparatus of claim 8, further comprising:
a device information command receiver which receives, from the first device, a device information command that indicates that a second device registered on the association device list does not associate with the piconet,
wherein when the device information command receiver receives the device information command, the association device list maker deletes the second device from the association device list.

12. The apparatus of claim 8, further comprising:
a peer information command receiver, which receives, from the first device, a peer information command that indicates that communication between the first and second devices has ended; and
an association elapsed period resetter, which, when the peer information command receiver receives the peer information command, resets association elapsed periods of the first and second devices,
wherein the association device list maker records the reset association elapsed periods of the first and second devices.

13. A system that manages associations of devices with a piconet, comprising:
a piconet-device association coordinator, which receives, from a first device, a second association request command that indicates a proper allocation of a device ID to the first device, sets an association elapsed period of the first device to an initial value, and registers the first device and records the association elapsed period to an association device list so that the first device corresponds to the association elapsed period; and
a piconet-device associator, which updates an association device list of the first device by referring to the association device list, extracts an association elapsed period of a second device registered on the updated association device list from the updated association device list when the first device requests communication with the second device, and performs the communication between the first and second devices if the extracted association elapsed period is shorter than an association timeout period.

14. A method of associating devices with a piconet, the method comprising:
updating an association device list of a first device by referring to an association device list, on which the devices associated with the piconet are registered and association elapsed periods of the devices are recorded;
if the first device requests communication with a second device registered on the updated association device list, extracting an association elapsed period of the second device from the updated association device list; and
if the extracted association elapsed period is shorter than an association timeout period, performing the communication between the first and second devices.

15. The method of claim 14 further comprising:
receiving a beacon that comprises the association device list from a piconet coordinator, which manages the piconet,
wherein the updating of the association device list of the first device is updated by referring to the association device list of the beacon.

16. The method of claim 15 further comprising:
transmitting, to the piconet coordinator, a first association request command to request an allocation of a device ID to the first device;
receiving, from the piconet coordinator, a first immediate ACK that indicates that the first association request command has been properly received;
receiving, from the piconet coordinator, an association response command that comprises the device ID allocated to the first device;
transmitting, to the piconet coordinator, a second association request command that indicates that the device ID of the association device command has been properly allocated to the first device; and
receiving, from the piconet coordinator, a second immediate ACK that indicates that the second association request command has been properly received.

17. The method of claim 16 further comprising:
if the second immediate ACK is received, determining that the first device has associated with the piconet,
wherein in the receiving of the beacon with the association device list from the piconet coordinator, the association device list on which the association elapsed period of the first device has been recorded is received from the piconet coordinator.

18. The method of claim 14, further comprising:
if the extracted association elapsed period is not shorter than the association timeout period, transmitting, to the second device, a probe request command to request confirmation whether the second device has associated with the piconet;
receiving, from the second device, a probe response command that indicates that the second device has associated with the piconet; and
if the probe response command is received, performing the communication between the first and second devices.

19. The method of claim 18 further comprising:
transmitting a device information command that indicates that the second device does not associate with the piconet to the piconet coordinator if the probe response command is not received.

20. The method of claim 18 further comprising, transmitting a peer information command that indicates that the communication between the first and second devices has ended to the piconet coordinator if the communication between the first and second devices ends.

21. A method of coordinating associations of devices with a piconet, the method comprising:
receiving, from a first device, a second association request command that indicates that a device ID has been properly allocated to the first device;
if the second association request command is received, setting an association elapsed period of the first device to an initial value; and
registering the first device and recording the set association elapsed period to an association device list so that the set association elapsed period corresponds to the first device.

22. The method of claim 21, further comprising:
broadcasting a beacon that comprises the association device list.

23. The method of claim 21 further comprising:
receiving, from the first device, a first association request command to request the allocation of the device ID to the first device;
if the first association request command is received, transmitting, to the first device, a first immediate ACK that indicates that the first association request command has been properly received;
if the first association request command is received, allocating the device ID to the first device;
transmitting an association response command that comprises the device ID to the first device; and
if the second association request command is received, transmitting to the first device, a second immediate ACK that indicates that the second association request command has been properly received.

24. The method of claim 21, further comprising:
receiving, from the first device, a device information command that indicates that a second device registered on the association device list does not associate with the piconet; and
deleting the second device on the association device list if the device information command is received.

25. The method of claim 21, further comprising:
receiving, from the first device, a peer information command that indicates that communication between the first and second devices has ended;
if the peer information command is received, resetting the association elapsed period of the first device to the initial value and resetting an association elapsed period of the second device to an initial value; and
recording the reset association elapsed periods of the first and second devices on the association device list.

26. A method of managing associations of devices with a piconet, comprising:
receiving, from a first device, a second association request command that indicates that a device ID has been properly allocated to the first device, setting an association elapsed period of the first device, and registering the first device and recording the set association elapsed period to an association device list so that the first device corresponds to the set association elapsed period; and
updating the association device list of the first device by referring to the association device list, extracting an association elapsed period of a second device registered on the updated association device list from the updated association device list if the first device requests communication with the second device, and performing the communication between the first and second devices if the extracted association elapsed period is shorter than an association timeout period.

27. A computer-readable recording medium on which the method of claim 14 is recorded as a computer-executable program.

28. A computer-readable recording medium on which the method of claim 21 is recorded as a computer-executable program.

29. A computer-readable recording medium on which the method of claim 26 is recorded as a computer-executable program.

30. A beacon frame comprising a field in which devices associated with a piconet are registered and association elapsed periods of the devices are recorded.

31. A device information command frame comprising a field that comprises a value that indicates that a predetermined device does not associate with a piconet, wherein the predetermined device being registered on an association device list on which devices associated with the piconet are registered and association elapsed periods of the devices are recorded.

32. A peer information command frame comprising a field that comprises a value that informs a piconet coordinator that communication between devices associated with a piconet has ended, wherein the piconet coordinator manages the piconet.

33. A computer-readable recording medium on which a data structure comprising the beacon frame of claim 30 is recorded.

34. A computer-readable recording medium on which a data structure comprising the device information command frame of claim 31 is recorded.

35. A computer-readable recording medium on which a data structure comprising the peer information command frame of claim 32 is recorded.
